(19) United States
(12) Patent Application Publication
(10) Pub. No.: US 2005/0257269 A1
(43) Pub. Date: Nov. 17, 2005

(54) Cost effective incident response

(76) Inventors: Suresh N. Chari, Tarrytown, NY (US); Pau-Chen Cheng, Yorktown Heights, NY (US); Pankaj Rohatgi, Hartsdalen, NY (US); Charanjit Singh Jutla, Elmsford, NY (US); Josyula R. Rao, Briarcliff Manor, NY (US); Michael Steiner, New York, NY (US)

Correspondence Address: Thomas A. Beck Esq., 26 Rockledge Lane, New Milford, CT, 06776, US

(21) Appl. No.: 11/121,359

(22) Filed: May 3, 2005

Related U.S. Application Data
(60) Provisional application No. 60/567,609, filed on May 3, 2004.

(51) Int. Cl. H04L 9/00

(52) U.S. Cl. 726/25

(57) ABSTRACT

A response system which produces strategies to contain hosts compromised by a worm. One minimizes the damage so caused and the loss of business values induced by actions taken to protect a network. The approach uses logical representation of the target network. By abstracting low level information such as switches, routers and their connectivities, theoretical algorithms are used to find the optimal containment.

This application claims priority from Provisional Application Ser. No. 60/567,609 filed May 3, 2004.

### FIELD OF THE INVENTION

The present invention relates to an incident response security system which is used in conjunction with the Internet. The system is designed to plan proactively and respond automatically to security incidents, such as reported vulnerabilities and fast moving vulnerabilities that can occur in enterprise networks, electronic DMZ's (electronic demilitarized zones) and data center environments. The system contains such security incidents while trying to minimize the impact to business processes supported by the IT infrastructure in such environments. The containment actions are executed by a robust, flexible response infrastructure whose core is a rich and expressive scripting language designed explicitly for response. The system is designed to work in a wide variety of environments ranging from highly managed environments like DMZs to completely unmanaged networks.

### BACKGROUND OF THE INVENTION

Vulnerabilities in deployed computer systems and intrusions that exploit them are a major threat to enterprise networks and data center environments today. Such incidents are catastrophic from the perspective of the Internet user because such incidents result immediately in the interruption of critical business processes. Also the effects of intrusions such as worms are cascading since they spread and paralyze an entire target network.

Computer worms spread by infecting workstations/servers etc., exploiting bugs in software running on these machines. Once a worm infects a particular host, it uses the host as a springboard to discover other vulnerable hosts causing considerable impact. Such spreading is not limited to (automated) computer worms but it can also be caused by a human intruder manually penetrating resources of a network. Currently, response to intrusions is mostly manual partly due to lack of proper detection mechanisms. However, system administrators also lack a suitable support infrastructure providing intuitive and powerful response primitives to make educated, robust and fast response decisions. Therefore, response is currently, even in the presence of highly skilled personnel, often slow and error-prone. Furthermore, incident response can have an immense impact on the business process, and yet no support exists nowadays for the system administrators to assess the impact of potential response actions.

Similarly, even in cases where automated response is possible, programmers of a response strategy lack a common and powerful infrastructure to base their strategies upon (note that network management tools do not currently provide the right level of information and abstractions to handle this efficiently. Furthermore, they mostly do not address resources which are not under central control. However, these unmanaged resources are usually the most troublesome ones). This leads to a multitude of incompatible, uncoordinated and less-than-optimal response strategies.

A recent example is that of the W32/Blaster worm which successfully infected approximately 300,000 machines on the Internet and then performed a denial of service attack against web servers distributing patches for the security vulnerability that the worm exploits. The Blaster worm is especially illustrative since the underlying vulnerability, which enabled the spread, was known before the release of the worm.

When a system vulnerability is publicized or when activities indicative of an security intrusion are deduced, swift action must be taken to contain damage and to remediate the network so that critical business processes are not interrupted. Response mechanisms in practice today tend to be reactive, overwhelmingly manual, labor intensive, and largely ignore business process considerations. Essentially, system administrators scramble when notified of an incident with little automation to assist in their tasks.

This state of affairs is woefully inadequate for several reasons. First, the damage to the infrastructure due to an intrusion such as the spread of a worm is so quick that a manual response is often too slow to be effective. Second, and more important, containing a security intrusion comprehensively is difficult to achieve by manually chosen response actions at the time of the incident. Even if this were possible, manual response actions typically tend to be error-prone and overkill and result in the unnecessary termination of network connectivity and/or server programs, which unduly penalizes unaffected systems and adds to the cost of response.

Thus, it is increasingly clear that any scalable response architecture should take advantage of proactive preparation to avoid scrambling at the time of the security incident and must automate as many aspects of analysis and execution as possible. Care must be exercised on what triggers the automated response. Traditionally sensors which detect intrusions like intrusion detection systems are prone to high false positive rates. Therefore the trigger for automated response must be manual.

While there have been some attempts to automate response as described by Vu A. Ha, et al. in Balancing Safety against Performance: Tradeoffs in Internet Security, Proceedings of the 36^{th} Hawaii International Conference on System Sciences (HICSS 36), Big Island, Hi., January 2003, and David Musliner, et al. in Reasoning About Timeliness for Computer Security Reactions: CIRCA and AIA experiment 001, Proceedings of the DARPA Information Survivability Conference and Exposition (DISCEX 2001), pages 299-307 (the contents of which are hereby incorporated by reference herein), these approaches ignore the impact of the response on the business process being realized by the target network. The implemented business process inherently assigns a value to each host element in the network and the value of the services it offers. A response action that terminates a service on a host or shuts down a host, incurs a cost which is proportional to the value of these services/hosts.

A very important requirement for automating response is a robust infrastructure that can be used to contain the impact of a vulnerability or intrusion quickly. While a number of network and systems management tools exist, there are very few languages, frameworks and tools that enable the execution of a wide spectrum of response actions securely and comprehensively. In the event of a security intrusion, such a response platform would be key to limiting the total number of hosts attacked and containing the damage.

The closest related work embodied in the works by Ha, et al. and Musliner, et al. cited above, derive reactive strategies based on control-theoretic methods to act locally on host-intrusions. While they mention the possibility of using it offline, they seem to focus more on real-time planning. Furthermore, their current attack model is rather ad-hoc and the authors ignore the issue of sensors and their false positive and negative characteristics.

With respect to the various parts of the preparation phase of the present invention, there are other related works. A somewhat similar use of network discovery tools for security is discussed by Giovanni Vigna, et al., Composable Tools for Network Discovery and Security Analysis, 18^{th} Annual Computer Applications Conference, Las Vegas Nev., USA December 2002, the contents of which are hereby incorporated by reference herein.

Automatically derived network information is exploited by ClearResponse from Psionic (http//www.psionic.com/) in enhancing the filtering of alerts. However, none of these approaches exploit this information for improved response such as is used in the target class signatures explained in greater detail hereinafter. There are several research projects about defense systems against worms, but none has discussed the business impact of protective actions. Moore, et al. in The Spread of the Sapphire/Slammer Worm, Technical Report February 2003 (the contents of which are hereby incorporated by reference herein) studied requirements for containing worms. They compared signature-based filtering and black-list filtering. They compared several different ways to deploy signature-based filtering. Nojiri, et. al. in Cooperative Response Strategies for Large Scale Attack Mitigation, Proceedings of the Third DARPA Information Survivability Conference and Exposition (DISCEX 2003), IEEE Computer Society Press 2003 (the contents of which are hereby incorporated by reference herein) proposed a peer-to-peer based defense system where defense systems exchange information about worm activities and filter traffic to prevent further infection. Their focus is on a large scale network such as the Internet, and their idea is based on simplified topology.

Finally, prior art work on cost functions are disclosed by Lee, et al. Toward Cost-Sensitive Modeling for Intrusion Detection and Response, Journal of Computer Security, Wei, et al., Cost Benefit Analysis for Network Intrusion Detection Systems, CSI 28^{th} Annual Computer Security Conference, October 2001 and in particular, Toth, et al. Evaluating the Impact of Automated Intrusion Response Systems, 18^{th} Annual Computer Applications Conference, Las Vegas Nev., USA December 2002, (the contents of which are hereby incorporated by reference herein). The latter is pertinent with respect to the present invention, however description of the system disclosed therein is framed only in the context of response and does not take into account the infection. There have been several ideas on “response” in the literature. One of the earliest systems was EMERALD described by Porras, et al.: Event Monitoring Enabling Responses to Anomalous Live Disturbances, 20^{th} National Information Systems Security Conference, pages 353-365, October 1997 (the contents of which are hereby incorporated by reference herein). The focus in the aforementioned treatise was on the aspect of global detection rather than response.

There also has been work on taxonomies on response such as that described by Carver, et al. in An Intrusion Response Taxonomy and Its Role in Automatic Intrusion Response, Proceedings of the First IEEE Information Assurance and Security Workshop, West Point, N.Y. USA, June 2000 (the contents of which are hereby incorporated by reference herein). Among the deployed solutions, CITRA comprising Cholter, et al., IBAN: Intrusion Blocker Based upon Active Networks, Proceedings DARPA Active Networks Conference and Exposition (Dance 2002), pages 182-192, San Francisco, Calif. USA, May 2002; Steme, et al., Active Network Based DDoS Defense, Proceedings DARPA Active Networks Conference and Exposition (Dance 2002), San Francisco, Calif. USA, May 2002; Steme, et al. Autonomic Response to Distributed Denial of Service Attacks, Recent Advances in Intrusion Detection, Proceedings of the 4^{th} International Symposium (RAID 2001) Volume 2212 of Lecture Notes of Computer Science, pages 134-149 Davis, Calif., USA, October 2001, Springer-Verlag, Berlin Germany; Schnackenberg, et al. Infrastructure for Intrusion Detection and Response, Proceedings of the DARPA Information Survivability Conference and Exposition (DISCEX 2000). IEEE Computer Society Press, January 2000; (the contents of which are hereby incorporated by reference herein) all provide an infrastructure supporting global policies and coordination. However, their scope is limited to DDoS. Furthermore, they do not deploy any planning phase to develop the strategies and have limited focus on survivability. SARA: Survivable Autonomic Response Architecture as described by Lewandowski, et al. in the Proceedings of the DARPA Information Survivability Conference and Exposition (DISCEX 2001) (the contents of which are hereby incorporated by reference herein) is an extensible framework for coordinated response with focus on survivability. However, it also does not do any preparation and planning.

While there is considerable of work on a whole spectrum of response actions ranging from drastic actions such as blocking traffic to moderate response such as virus throttling as described by Williamson in Throttling Viruses: Restricting Propagation to Defeat Malicious Mobile Code; or the system call delays disclosed by Somayaji, et al. in Infrastructure for Intrusion Detection and Response and Somayji, Operating System Stability and Security Through Process Homeostasis, Ph.D. Thesis, University of New Mexico, July 2002, (the contents of which are hereby incorporated by reference herein), there is no work on measured responses minimizing disruptions in a global business process context.

### SUMMARY OF THE INVENTION

This invention proposes a novel means for eliminating the problems extant in the prior art and provides a novel method for the automatic impact containment of network intrusions.

Elements which comprise the invention include a knowledge system for collecting and classifying asset and cost information about a network system, a simulation system relating to a cost effective incident response security system and a cost effective incident response security system which provides for the automatic or semi-automatic impact containment of vulnerabilities and/or intrusions. There are tools associated with the system which generate, assess/evaluate and optimize response strategies to vulnerabilities and/or intrusions in the network system.

More particularly, the response actions taken will attempt to ensure that all resources that are identified or suspected as having vulnerabilities and/or intruded will correctly be isolated from the rest of the network. Resources vulnerable to the attack will be further protected to limit the impact of the vulnerability and/or intrusion. Importantly from a commercial perspective, care is taken to optimize the net cost in terms of the business impact of the interrupted services and infected hosts. First, the alarms issued from sensors such as intrusion detection sensors, anti-virus software, security auditors etc. or out-of-band mechanisms such as security advisories are analyzed to identify the target class of interest, i.e. the characteristics of affected resources. This serves to restrict the size of the domain of resource classes considered for optimization.

Once the right domain is identified, a number of possible optimization algorithms are applied to identify which services or resources have to be terminated or reconfigured. Examples of such actions are to apply a patch and reboot a server, filter or throttle traffic or to switch to a service mode with more limited intrusion risk and/or impact.

Further, some techniques are applied to solve this optimization problem by reducing it to graph theoretic optimization techniques such as minimum cuts in graphs. Other optimization techniques which optimize other parameters of this solution are also disclosed. The exact choice of which technique to use will depend on the costs and the actual intrusion scenario.

Alternately, an embodiment of the invention uses an evaluation environment, which after discovering the concrete topology and the associated value of resources, can be used to simulate the cost impact of responding to a given intrusion scenario using a given strategy. The user/administrator can evaluate different optimization strategies to choose the best choice of response strategy given a concrete intrusion scenario. In addition, this simulation environment can thus be used to identify the worst-case cost of intrusion given the current topology and also be optionally used to identify trouble spots and the effect of adding more detection/response elements.

Thus key elements of the method of the present invention are the identification of the right domain of optimization and the proper choice of an optimization technique to apply to the identified vulnerability and/or intrusion scenario. This choice can be arbitrarily chosen from some techniques which are described or can be chosen a priori using the offline evaluation environment to simulate appropriateness of the different strategies.

Finally, once an optimal set of response actions are identified, they can be automatically or semi-automatically (or triggered by human command) executed. Thus, the instant method will ensure the timely execution of correct responses which minimize the costs incurred. The instant incident response system has two main features that directly address the shortcomings of current proposals to automate response to vulnerabilities and/or intrusions:
1. It uses combinatorial optimization techniques to minimize the impact of response actions on the business process given the available control points in the target network; and
2. Response actions are executed in a framework comprising a rich and expressive scripting language and a robust actuation platform.

In order to optimize the cost of response, a value is assigned to the host elements in the network and to the services they offer. Optionally, a cost can also be added to key network elements. This valuation of hosts and services can be derived from the business process supported by the target network. This is fairly straightforward in DMZs where it is much easier to quantify the value of elements. Alternately, the incident response system can also work with qualitative assignment of values such as a high, medium or low style classification. The cost of a set of response actions is the resulting net loss in the value of the hosts and services in the target network. It is assumed that the discovery of all of the hosts and services in the target network and the assignment of value from the business process is done periodically offline.

The instant incident response system makes no assumptions about what control points are available in the target network for response and does not mandate response capabilities for host or network elements. The cost of response will clearly be dependent upon the availability of enough control points in the target network to actuate response actions.

An object of the present invention is to work in a wide variety of environments ranging from highly managed data-center type environments where the operator could have the fine grained ability to control or to reconfigure a service running on a host, to completely unmanaged environments where the only response that can be taken will be on infrastructure elements such as switches and routers. The optimization techniques will try to identify the best possible set of response actions to contain a vulnerability or intrusion, given the control points actually resident on the target network. A concept which is particularly advantageous in the design of the instant incident response system is that of a target class signature. This is a quick and succinct characterization of the class of hosts or services that are affected by the current vulnerability/intrusion factors.

By way of illustration, the target class signature for the W32/Blaster worm would be Win2000/XP machines running the distributed common object model remote procedure call (DCOM RPC) service. It is envisioned that the incident response system could be used for effective containment using successive refinement of target classes as more information about the affected class of machines becomes known. Target classes are also of use in proactive planning for response.

The incident response system does not address the issue of detection of vulnerabilities/intrusions since there is a large universe of such tools already available. Also, in the current design of the incident response system the triggers for identifying and actuating response actions is manual through a target class signature given by the operator. There are a number of false positives in current detection systems. It is believed that it is better to use automated response triggered by manual command. This is a “semi-automatic” response.

When triggered, the incident response system will use the target class signature to identify an optimal set of response actions, given the currently existing set of control points in the target network.

Combinatorial optimization techniques are utilized in the system to minimize the cost of response actions. In a number of cases, it is possible to reduce the problem of optimal containment to the graph-theoretic problem of computing the minimum cut. A discussion of this topic is found in Introduction to Algorithms by Cormen, Leiserson and Rivest, Number Cambridge, MIT Press 1990, (the contents of which are hereby incorporated by reference herein). This optimization component will identify an explicit set of high level actions that need to be taken to contain the vulnerability/intrusion. Examples of such actions are disabling ports of a switch or router, reconfiguring filtering rules on switches and routers, terminating server programs, shutting down hosts, applying new local firewall rules, etc.

Since the minimum cut problem can be efficiently solved using the didactics found in Introduction to Algorithms cited above, one can compute the optimal set of response actions for a number of cases. To effect such response strategies, the incident response system architects and prototypes a distributed response platform which provides an abstract and coherent interface to the various previously identified actions and their platform dependencies. To support administrators in fail-safe and timely ad-hoc remediation actions, incident response system also provides them with a simple yet powerful scripting language and shell. The key features of the language are the possibility to intelligently aggregate resources based on various characteristics, and to execute operations jointly on the whole aggregate. The response platform component of incident response system is rich enough to cleanly express a large class of response actions and is a valuable tool independent of what strategies are used in response.

Another important feature of the incident response system is that in a number of cases, responses can be planned proactively. For highly managed environments such as DMZs where elements have a high business value, operators of the incident response system can proactively identify a set of prepared response plans for a number of target classes. This can be done by off-line simulation of available containment strategies as well as actuator placement to identify the best strategy for these target classes. For these cases, essentially the optimal response actions can be computed a priori. Upon receiving a trigger, one could directly jump to the deployment of such response actions. With similar war-gaming, one can also evaluate the most cost-effective selection and placement of actuators.

The instant incident response system protects a target network such as an enterprise network or a data-center. Such a networked environment typically consists of a heterogeneity of host elements (such as personal computers, workstations and servers) connected by equally diverse network elements (such as switches, routers and gateways) that are typically connected to the Internet via firewalls. The design of the incident response system deals with both the case where the environment is fully managed, in that each host and network element is under the administrative control of a single entity, as well as the more important case where the network has grown organically and it is likely that the host and network elements are in different administrative domains.

The invention is composed of a number of embodiments including a knowledge system, a simulation system, an incident response security system to manage vulnerabilities and/or intrusions in a network and a cost effective incident response security system which provides for the automatic or semiautomatic impact containment of the manage vulnerabilities and/or intrusions.

The knowledge system for collecting and classifying asset and cost information about the network system noted above is implemented by means for collecting information about all resources and services in the network system; means for collecting information about the dependencies between the resources and the services in the network system; means for associating values with the resources, services and dependencies noted above; means for determining an expected repair cost of a vulnerability and/or intrusion and means for classifying collected information about the network system to form a target class signature by identifying resources and services which can be targeted by the same vulnerability and/or intrusion.

The simulation system of the invention utilizes the means possessing the knowledge system described above and in addition contains a means to model vulnerabilities and/or intrusions; means for simulating the behavior of the network system for a given response strategy and a given vulnerability and/or intrusion model and means for assessing an expected cost of vulnerabilities and/or intrusions as determined by the aforementioned vulnerability and/or intrusion model and response actions determined by the response strategy in terms of expected loss in the value of resources, services and dependencies and expected repair cost in the simulation.

With respect to the simulation system, the invention embodies tools to generate, assess, evaluate and optimize configurations of the network system. Using the simulation system, one of the tools has means for generating different configurations of the network system and means for evaluating the effectiveness of the configurations based upon the simulation system. Another tool, in using the simulation system noted above, has means for generating different strategies of the network system and means for evaluating the effectiveness of the strategies based upon the simulation system.

The incident response security system manages vulnerabilities and/or intrusions in a network system using the knowledge system, a set of actuators which in turn implement a set of basic commands, a distributed runtime system which provides the capability of invoking a set of high level commands on an aggregated set of actuators in terms of the basic commands supported by the actuators and a language and a related interactive shell that provides an interface to the distributed runtime system.

The invention also includes the cost-effective incident response security system which provides for the automatic or semi-automatic impact containment of vulnerabilities and/or intrusions. It uses the incident response security system described above, and upon detection of a vulnerability and/or intrusion in the network system using the incident response security system, it implements a means to identify a target class signature for the vulnerability and/or intrusion. After identifying the target class signature means for applying optimization algorithms to obtain an optimal set of response actions on the resources and on the services which will minimize the expected cost of the vulnerability and/or intrusion in terms of expected loss in the value of resources, services and dependencies and expected repair cost. An optimal set of response actions is then executed.

All of the elements of the invention as described above can be implemented using a computer program product having a computer useable medium including a computer readable program, wherein the computer readable program when executed on a computer causes the computer to collect and classify asset and cost information about the network system to form a knowledge system.

### BRIEF DESCRIPTION OF THE DRAWINGS

FIG. 1 is an enterprise network topology layout.

FIG. 2 is a sample target class graph depiction of elements in the incident response.

FIG. 3 is a service link table for HTTP.

FIG. 4 is a node aggregation in the same LAN.

FIG. 5 is a logical representation of secondary effects in the system.

FIG. 6 is a graph depicting node costs and primary and secondary costs.

FIG. 7 is a converted graph.

FIG. 8 is an illustration of a “one hop search.”

FIG. 9 is an illustration of a “bad move.”

FIG. 10 is an architectural overview.

FIG. 11 is architectural layering of the system.

FIG. 12 is the relationship among important classes in the resource model.

### DESCRIPTION OF THE PREFERRED EMBODIMENT

Some key technical means in the system and method of implementing same are the following:

Discovery of resources: The initial feature to is to use common discovery tools to scan the current domain of interest to discover all the existing resources i.e. computers routers, switches, services running on various resources etc. This is typically done with commonly available network discovery tools. Alternately, one can assume that a comprehensive listing of the networked resources is provided as an input to the system.

Annotation with costs: One feature of the invention is to minimize the business cost of response to intrusions. These costs quantify the value of the resources of the target network themselves, the cost of an infection and following repair, and the values that services running on these resources provide to the consumers of such services. The consumers can be resident in the target network or be external. External consumers are represented by a clearly designated set of external nodes. For example, the Internet is typically represented as an external node consuming all services visible to clients on the Internet. An explicit description of how these costs are assigned is not presented since these are dependent on the actual business process being implemented by the networked resources. It is assumed that an annotation of such costs will be provided to system and method.

Integration with alarms: Response actions are triggered by alarms. These alarms are typically yintrusion detection sensors, anti-virus software, etc. Alternately, they can be manually generated based on security advisories etc. While the system will design responses based on the output of the alarms, there will be no explicit details presented here for the generation of such alarms i.e. the detection of attacks. It is assumed that some information with which the system works in response to, can be derived from the alarms generated by all commonly available sensors.

The above means/elements are typically utilized in a preparatory phase, typically in an offline mode, potentially re-validated in regular intervals; or on suitable occasions afterwards. The effectiveness of the system does not require that they be done and is just assumed as input to the main system. Hereinafter there is described another optional preparatory offline step which can be used to tune the optimizations to a particular intrusion situation.

Identification of target class: Upon the receipt of a set of alarms from the sensors the first step is to narrow the domain of the affected resources. This is done using target class signatures which are approximations to a characterization of the class of affected resources. These can be at arbitrary levels of granularity. Typical examples of such target classes are computers which run a particular operating system on a particular hardware. Other refinements are to only include computers that run a particular service, computers offering a particular service through a particular software package of a certain patch level etc. Alarms generated manually will typically directly identify a particular target class signature. Optimization algorithms generally will be run on a particular target class and as more information is available, the target class is refined and the algorithms are run once again, as more information is available. In the worst case, all the resources in the target network can be seen as a single target class. Once the target class signature is identified the domain of interest is restricted to those resources in the target network which match the identified target class signature. Using the costs given to us in the annotation of cost means described above, the operator will identify the costs of taking measures to protect the resources in the restricted domain such as terminating or reconfiguring the resources themselves or controlling network traffic via network control elements. This will not only include the costs of the directly affected resources but also any costs of indirectly affected resources outside the restricted domain.

For example, if terminating a service on one host requires action on network elements which affects services on hosts not in the target classes, then the costs of these indirectly affected services are assigned as indirect costs. Similarly, consideration of the potential infection costs of vulnerable resources left unprotected will also be considered.

Optimization: Once the domain of interest is identified and all the costs are assigned to various resources, an optimization algorithm is applied to obtain the set of resources and actions to perform which will attempt to mitigate the cost of infection. One of the algorithms uses solutions to the graph theoretic problem of minimizing the cost of a cut in a graph. How to reduce the problem of determining the optimal set of service links to terminate to solving an instance of the graph minimum cut problem must be considered. Then using one of the many ways to solve the minimum cut problem as disclosed in the prior art, the best set of links to terminate will be determined.

A determination is also made of another optimization which is cost agnostic but tries to minimize the distance to which traffic from an affected resource can travel. This is done by determining the network elements closest to the affected resource which can be used to filter traffic to/from the affected resource. The choice of which of these optimizations to use depends on the actual target topology, the target class and the costs assigned to resources. One could run both the algorithms and then evaluate the resultant costs choosing the best possible option OR one could determine this choice using the optional offline simulation phase described herein.

Evaluate cost: Once the optimization algorithms are used to determine which actions to take the operator evaluates the total cost impact prescribed by the optimization regimes.

Execution of response actions: Once the right optimization is used and if the resultant cost of response actions is computed an evaluation is conducted as to whether the response actions are taken. This is done by evaluating various parameters such as the magnitude of the costs, the trust in the sensors generating alarms etc. Alternately the execution of response actions could potentially be based on human command.

Optional simulation phase: This is an optional step which can be implemented after the target topology is discovered and the resource costs are assigned. In this simulation step, the operator could choose to simulate intrusion (spread) by infecting a particular resource with a intrusion of certain spread characteristics. The network elements are simulated carefully to replicate the spread of this intrusion and the reaction of the different sensors. Once the alarms are received at the computer implementing the optimization algorithms, or are directly input to simulate human generated alarms, steps are run to identify the target class, run optimization and evaluate the resultant cost. Thus, this gives a simulation of running a particular optimization strategy on a particular intrusion spread scenario.

The simulation phase can be thus used to determine which algorithm is to be used for a given target class/set of alarms.

Alternately, this step can be used as a means to quantify the worst case costs for response to intrusion spread given the current topology, costs and placement of detection sensors. This worst case cost analysis helps to perform risk management decisions and can lead to better network planning and/or placement of detection sensors.

The first step in implementing the incident response system of the present invention is to use common discovery tools to scan the current domain of interest to discover all the existing resources, i.e., computers, routers, switches, services running on various resources, etc. This is typically done with commonly available network and software configuration discovery tools. Alternately, it can be assumed that a comprehensive listing of the networked resources is provided as an input to the method.

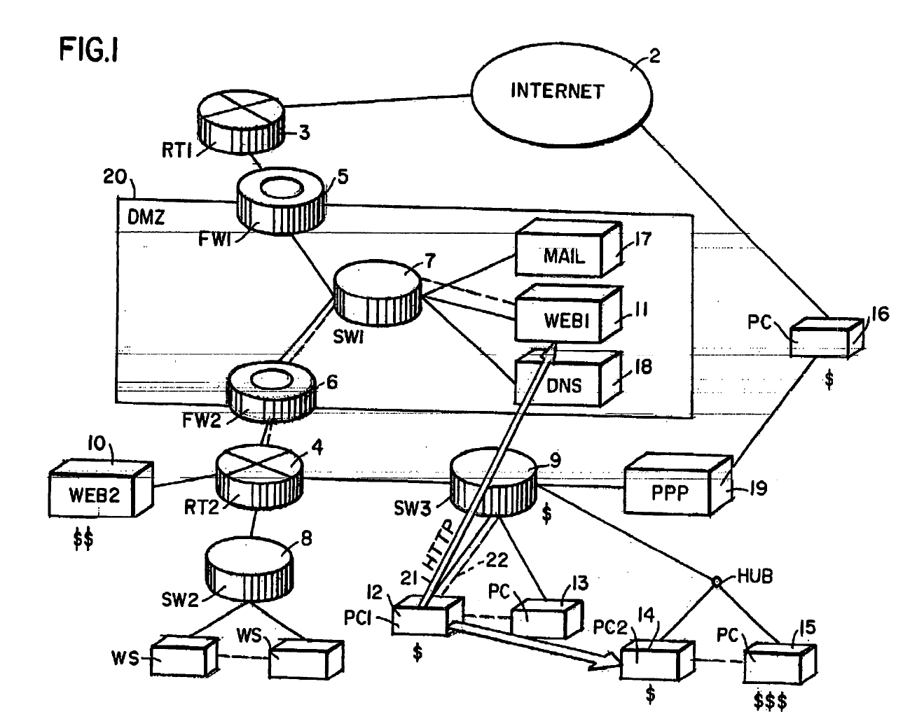

By way of illustration, FIG. 1 shows a typical enterprise network topology layout. Depicted therein are network elements (i.e. switches, routers, firewalls, hubs) and workstations, servers, personal computers, and the Internet. Between the two firewalls is a DMZ, where the mail server, the web server, and the DNS server are located.

In accordance with the present invention the networked environment depicted in FIG. 1 is modeled as a graph of resources where a resource can be viewed as one of a host system, a service on the host system, a switch, a router etc. Specifically depicted in FIG. 1 are network elements including internet 2 with connections (directly or indirectly) to routers, 3(Rt 1), 4(Rt 2), firewalls 5(Fw 1), 6(Fw 2), switches, 7(Sw 1), 8(Sw 2), 9(Sw 3), web 10(Web 1), 11(Web 2), PC's 12(PC 1), 13(PC 2), 14, 15, 16, mail stop 17, DNS 18, PPP 19, and DMZ 20.

A resource is, informally, anything that provides value to the rest of the network and its users. In the model used in accordance with the present invention, a normally functioning resource can become affected due to vulnerabilities, software errors, misconfigurations etc. An affected machine can get infected when it is subverted by a security intrusion. Notification of such an infection can be obtained from an intrusion detection system (IDS). In some situations, it may not be possible to definitively ascertain the infection status of an affected machine. Such a machine is termed to be suspect. An affected machine that is neither infected nor suspect is termed to be vulnerable.

Together, the classes of infected, suspect and vulnerable machines constitute the class of affected machines.

A key factor in the management of security incidents is the availability of control points in the network that enable an administrator to contain machines to either repair vulnerabilities or contain intrusions. An embodiment of the invention incident response system does not mandate specific response capabilities on any element; rather it works with existing response capabilities on each infrastructural element. For instance, a highly managed server may offer a fine-grained ability to control or even reconfigure a particular service running on the machine. On the other hand, an unmanaged host may offer no control points and thus, any response action affecting this machine must be done at the network infrastructural level. For instance some network switches offer a range of response possibilities ranging from simply turning a port off to very fine grained filtering of traffic on a particular TCP from a machine. The cost of containing an incident will directly depend on the amount of control the enterprise has on the elements in the topology.

Most of the networked environments that are targeted by an embodiment of the incident response system conceptually implement a business process of one kind or another. This business process is usually implicit in the network topology and infrastructure but can be more explicit in other cases. A centerpiece of the incident response system approach is to take advantage of business process considerations in preparing for and responding to notifications of vulnerabilities and security intrusions. In particular, the instant system uses the ideas of a service link, a service link graph and a cost model to capture salient aspects of the business process in implementing the present invention's functionality.

A service link is a logical link directed from a client to a server to indicate that the client uses a service that the server provides. In FIG. 1, there is a service link 21 from PC 12 to WEB 11 which indicates PC 12 has access to WEB 11 using the http protocol 21. PC 12 has another service link 22 to PC 14 using Windows file sharing service. Note that existence of a service link depends on the configuration of the network elements. For example, in FIG. 1, if Firewall 6 is blocking access to PC 12, then PC 12 does not have a service link to WEB 11.

While business process dictates which hosts need to use which services, there are other links possible due to configuration of routers and switches. For instance, there might be a path available from a host A to B even though the business process does not mandate this. Since a security incident such as a worm infestation can propagate via this available path, the model records a service link from host A to B.

A graph that comprises of the host and network elements as nodes and the service links as edges is termed the service link graph. If a target network offers services accessible from the Internet, a node W is created to represent the Internet and create service links from the W to the respective services. In the terminology used in the description of the present invention, W is always considered to be suspect.

In implementing the incident response system of the present invention, it is necessary to prepare a cost model for containment. The notion of a service link is a first step in capturing ongoing business activities in a network. To quantify the business value of these activities, an asset value is assigned to each service link and to each host element in the network. Asset values quantify the importance of the asset from a business process perspective and are based on a number of factors such as the criticality of the services a host provides, the sensitivity of data it stores etc. Asset values of a service are based on the value of the service to the business process. For instance, a web server of a mail order clothing firm that supports e-business transactions from the Internet generates revenues at a rate that varies seasonally. At a first approximation, one can assign an asset value to the service link to represent the revenue that is generated on a particular day based on historical data. However, it may be difficult to assign values to service links such as the one between an employee's PC and a mail server. In this case, one assigns a qualitative value based on the degree of importance. For example, a service link from a customer service representative's PC to a mail server could be assigned a higher asset value than that of a service link from any other regular employee's PC that does not support such a crucial function.

Any service link arising from existing paths through the network topology, which is not explicitly mandated by the business process, is assigned a zero value. The asset value of the service link represents the cost incurred by the business if response actions required the link to be terminated

Similarly, asset values are assigned to hosts. For example, the back-end database server supporting the web server which stores details of payment information for mail order customers, would have an asset value proportional to the data that it stores.

In many security incidents, especially worm attacks, termination of service links provides an effective way of both containing infected and suspect machines and isolating vulnerable machines especially if the attack uses service link as a means of propagation. Clearly, termination of a service link results in the loss of critical services in the network that affect the business process that it implements. In the model under consideration, the impact of terminating a service link is captured in terms of a cost, called the primary cost. “Primary Cost” is the cost directly incurred by the business process if the link is terminated and is effectively the asset value of the service link described above.

Service link termination can be performed in several different ways. The actions that one can take will depend on the control points that are available on the network elements and the host elements on the service link. For example, in FIG. 1, dotted arrows 22 represent an infrastructural path from PC 12 to WEB 11. There are multiple ways to terminate this link: i.e., reconfiguring one of the switches, routers and firewalls on the path, or applying a new local firewall rule on WEB 11. On the other hand, one has fewer choices to terminate service link from PC 12 to PC 14. If one has no other choices than disabling the port of a switch to terminate the link because of the lack of the capability of the switch, one is forced to terminate other service links. Some switches provide fine grained filtering capability. Hence, one does not need to affect other services to block the traffic from PC 12 to PC 14 while some switches do not provide such capability. This “forced link termination” due to the infrastructural constraints of network devices, is called a secondary effect, and the cost caused by secondary effect is called secondary cost. This is the collateral cost of terminating other service links in the process of terminating a given service link and directly reflects the amount of control the administrator has on elements in the topology.

There are several other subtle complexities in the assignment of value and the computation of response cost which are omitted here. For the purposes of describing the present invention, service dependencies in the target network are ignored; for example, a web server might depend on the services of an application server and a database server and might not work if either is terminated. This is a simple example of a conjunctive dependency. In describing the present invention, it is assumed that dependencies are disjunctive. Also, when computing the cost of response actions, transitive costs are also ignored, i.e., when a service is affected all the services which need this service are affected, etc.

Security vulnerabilities and intrusions can be characterized in terms of the characteristics of the affected target machines. For the purposes of the description herein, this is called the target class signature for the security incident. Typically, it would be expressed in terms of the operating system and name and version of a vulnerable program. For example, the target class for the W32/Blaster worm is, e.g., Windows NT 4.0/2000/XP/2003 Server machines running the RPC DCOM RPC interface. Similarly, the target class for the SQL Slammer/Sapphire worm is machines running SQL Server 2000 and Microsoft Desktop Engine 2000 on port 1434/UDP.

The key idea underlying the target class concept is that one can iterate over different target class signatures deployed in the network topology and prepare for the hypothetical eventuality that vulnerabilities in such a target class could be exploited in the future. This can be done by controlling deployments conformant with the risk to one's business process on such machines and ensuring the availability of a sufficient number of control points to contain such a target class should the threat materialize. In this way, the concept of target class is crucial to protecting against attacks with unknown signatures.

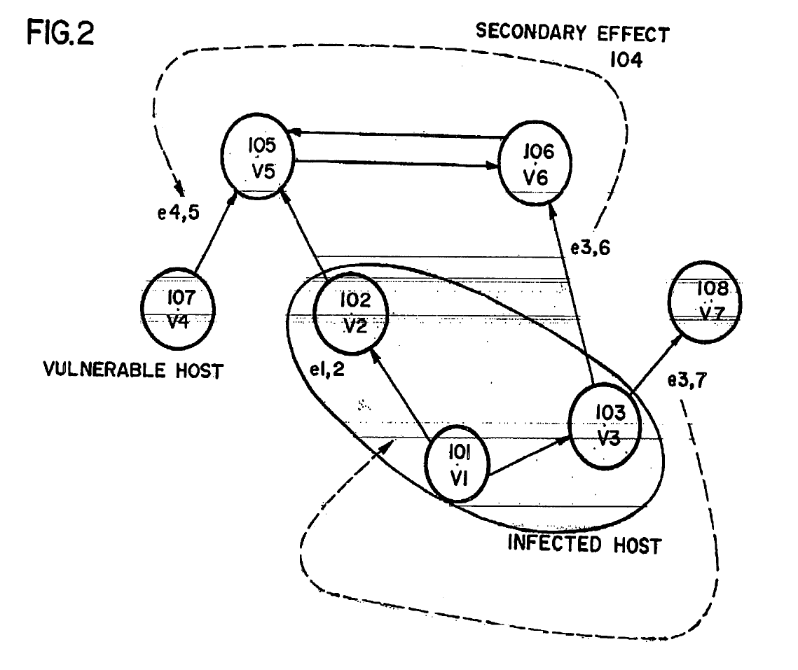

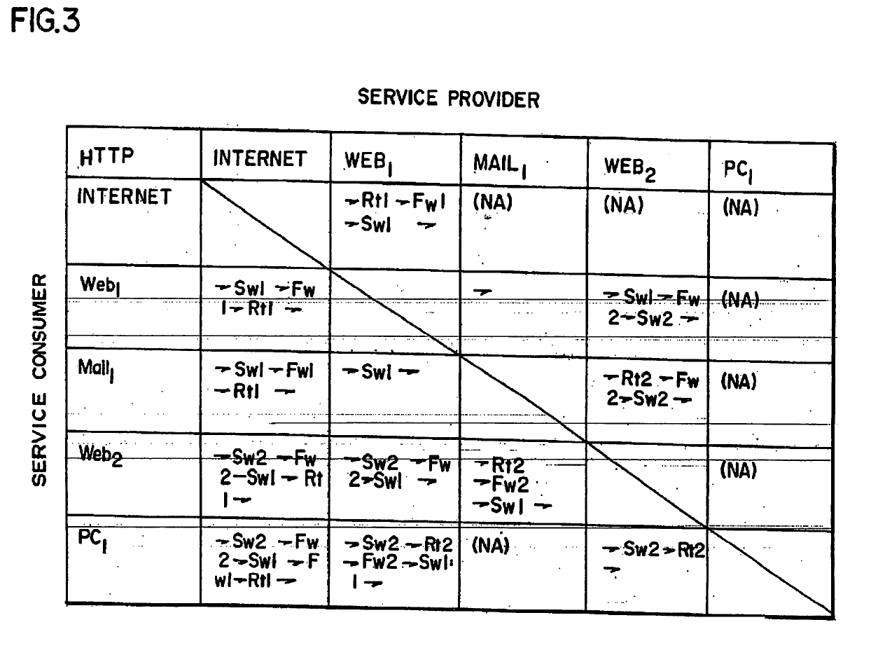

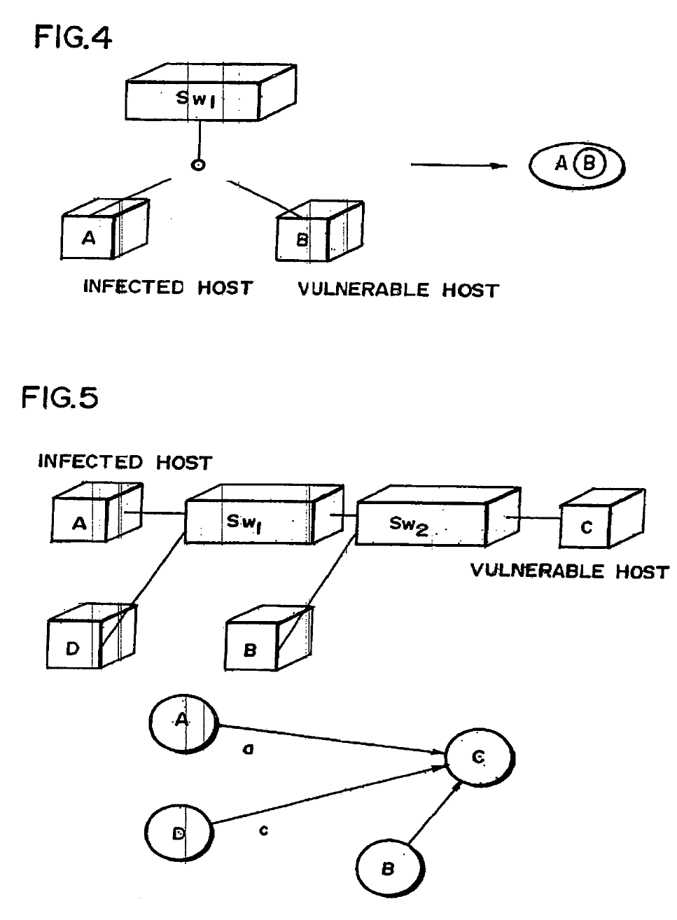

Once a target class has been identified, present invention incident response system forms a graph. This graph is called a target class graph and is depicted in FIG. 2. A target class graph is a directed graph, where the vertices denote hosts that belong to the target class and edges represent service links. Nodes are assigned their asset values while edges are assigned two non-negative values: e.g., primary cost and secondary cost as described hereinabove. The infected hosts 100 in FIG. 2 are depicted as v₁101, v₂102 and v₃103. The hosts within the secondary effect 104 are v₅105 and v₆106. Vulnerable host v₄107 and host v₇108 are not within the set of infected hosts. The elements e_{xy} represent edges (e) and the subscript elements (_{xy}) represent the pair of hosts connected, e.g., e_{1,2} connects v₁101 to v₂102, . . . etc.

In terms of the functional description of the system, the functionality of the incident response system is implemented in two phases: the offline phase and the online phase.

In the offline phase, the incident response system gathers detailed knowledge of the target network and the business process that it implements. This is intended to better prepare the infrastructure for the online phase.

In the online phase, the instant incident response system receives notifications about vulnerabilities/intrusions. Based on these notifications, it identifies the target class of machines affected and algorithmically determines the best strategy to respond to the vulnerability/intrusion that would cause minimal disruption to the business process. This strategy framed in terms of abstract high level actions is then implemented by mapping to low level response actions and orchestrating the execution of the actions across the infrastructure.

The instant response system uses existing tools to discover and gather as much information about the target network as possible. This includes information about all the host systems and network elements and the network topology. For each host system, the incident response system gathers detailed configuration information about the supported software and services such as the operating system and its version, running services, etc. Similarly, for each network element, the incident response system gathers information about the supported software.

The first step in containment is to identify a target class graph defined as follows:

A target class graph G=(V,E) is a subgraph of G where nodes V={v₁, v₂, . . . vₙ}are the hosts that belong to a certain target class, and the edges E=E={e₁, e₂ . . . eₘ} are the service links found among {v₁, v₂, . . . vₙ}

A containment is defined as a collection of hosts which are to be isolated from affecting the rest of the hosts in the target topology. In deriving containment, let I denote the set of nodes in G which are already found affected. A containment C is a set of nodes of graph G, with all the affected nodes in it, namely, I⊂C⊂V. With respect to the present invention, element I always contains the special node W representing the Internet. Further, in this disclosure, the term “affected” is used to denote infected or suspect machines.

It is necessary to capture formally all the costs incurred in the containment of the incident. Given a containment C, on a target graph class G, edges are grouped, depending whether they are in a containment or on the boundary: θ(C) denotes the set of edges with both endpoints in C, δ(C) denotes the set of edges with the tail end in C and the head end in V\C. These sets of edges have different impact on the total cost of the containment since it is necessary to explicitly cut the service links in the set δ(C) whereas it may not be necessary to cut the links in θ(C) since all the vertices in C are considered lost.

There are several other costs to be accounted for: All the hosts in the set C will be contained and the services running on these nodes will be corrupted or lost. Thus, the cost must include the value of service links in the resource model graph with the tail end in the vertex set V\V and the head end in the set C. This set of edges is denoted λ(C).

Using these aforenoted definitions, it is possible to define a cost of a containment. Informally, the total cost of containment C, denoted Γ(C), is the sum of the primary costs of the edges in the set δ(C)∪θ(C)∪λ(C), the secondary costs of the edges in δ(C) minus the sum of all the double-counted secondary costs. This follows directly from the definition of primary and secondary costs.

As discussed hereinabove, there can be overlap in the secondary costs of terminating links that is captured formally in the following definition.

Given a containment C, a dependency α is a maximal subset of edges in δ(C) which have a secondary effect on a common edge of G. Given a dependency α, common edge is denoted e_{α}, and its primary cost P_{α}. A target class can have multiple dependencies. Let D={α₁, α₂, . . . αₖ} be the set of all dependencies in the target graph. Let E_{c} denote a set of all the edges relevant to a containment C, that is, E_{c}=δ(C)∪θ(C)∪λ(C). For a dependency αᵢ, if edge eₐ, is in E_{c}, then its cost has already been counted in the primary cost terms. Thus the secondary cost term in the informal definition of the cost of containment C counts the cost |δ(C)∩αᵢ, | times. If the edge e_{αi} is not in E_{C}, its cost will be counted |δ(C)∩αᵢ, |−1 times. The resultant formula double-counting of secondary costs due to dependency is given by the formula:

$$ɛ ( {α}_{i} , C ) = \{ \begin{matrix}\vert δ ( C ) ⋂ {α}_{i} \vert \cdot {p}_{{α}_{i}} & if {e}_{{α}_{i}} ∈ {E}_{C} \\ ( \vert δ ( C ) ⋂ {α}_{i} \vert - 1 ) \cdot {p}_{{α}_{i}} & if {e}_{{α}_{i}} ∉ {E}_{C}\end{matrix}$$

Using all of these mathematical preliminaries as described, it is possible to compute the total cost f containment C using:

$$Γ ( C ) {=}^{Δ} {\sum }_{{v}_{i} ∈ C} {a}_{i} + {\sum }_{{e}_{i} ∈ δ ( C ) ⋃ θ ( C )} {p}_{i} + {\sum }_{{e}_{i} ∈ δ ( C )} {s}_{i} - {\sum }_{{α}_{i} ∈ D} ɛ ( {α}_{i} , C )$$

The formal statement of the optimal containment problem follows. Given a resource model graph G, a target class graph G, a set I of hosts known to be affected, and set of dependencies D, it is necessary to find the minimum cost containment C.

Algorithmic Strategies With the formalism used to identify the totality of all costs associated with a containment, algorithms are presented herein which find an optimal containment for certain special cases. While there is no polynomial time algorithm for the most general case, the heuristics which are presented work effectively.

In implementing the incident response system, the first special case considered is the situation wherein there are no secondary effects in terminating service links. In the formal notation, sᵢ=0 for all edges eᵢ ∈ G, and the dependency set D is empty. This is representative of the case when the operator has a fine gain control of the hosts and infrastructure elements so that service links can be precisely terminated without affecting any other hosts or service links. This could be realized for example if the operator precisely filters a pair of hosts and a particular port on switches, firewalls and routers. In these graphs, it is clear that the smaller the containment is, the cheaper the total cost. The monotonicity can be seen by noting that there are no subtractions due to overlapping secondary effects. Thus the most optimal containment is to precisely quarantine exactly the known initial set of affected hosts.

In implementing the incident response system, the second special case considered is the situation if (G, D) has so secondary effects or dependencies then C=I. This consideration is of the case when terminating service links may have secondary effects but there are no dependencies. i.e., the secondary effect of terminating any link does not intersect with the secondary effect of terminating any other link. In the mathematical notation of the previous section, the dependency set D is empty. An example of such a scenario is when two different servers, say, a mail server and a DNS server are co-located and connected jointly to a port on a switch through a hub. Switching off the port on the switch because of a vulnerability in the mail server would also disable the DNS server. Thus there is a secondary effect to containing the mail server. Assuming that the rest of the topology can also be finely controlled close to the affected host, there are no dependencies. For this case, one can calculate an optimal containment by a reduction to the standard graph theoretic mincut problem defined as follows:

Given a directed graph G=(V,E) special vertices s and t, a cut C is a subset of vertices V such that s ∈ C and t ∉ C. The cost of the cut is the sum of weights of all edges with the tail end in C and the head end in V\C. The mincut problem for the user is to find a mininum cost cut.

While a containment of the target class graph is also a cut of the graph, there are key differences between the two problems: In the optimal containment problem, nodes are weighted, the cost of the containment includes edges with both ends in the cut. Further, the edges can have secondary costs which are counted only if they are cut edges.

An algorithmic transformation is described which converts the optimal containment problem to the mincut problem. This can essentially be done in linear time so the complexity of computing the optimal containment is essentially the same as that of the mincut problem.

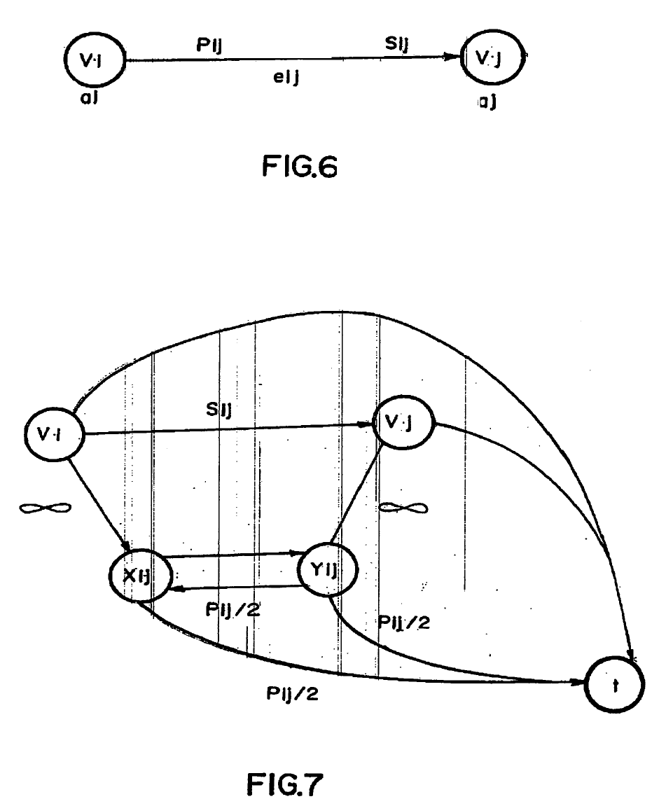

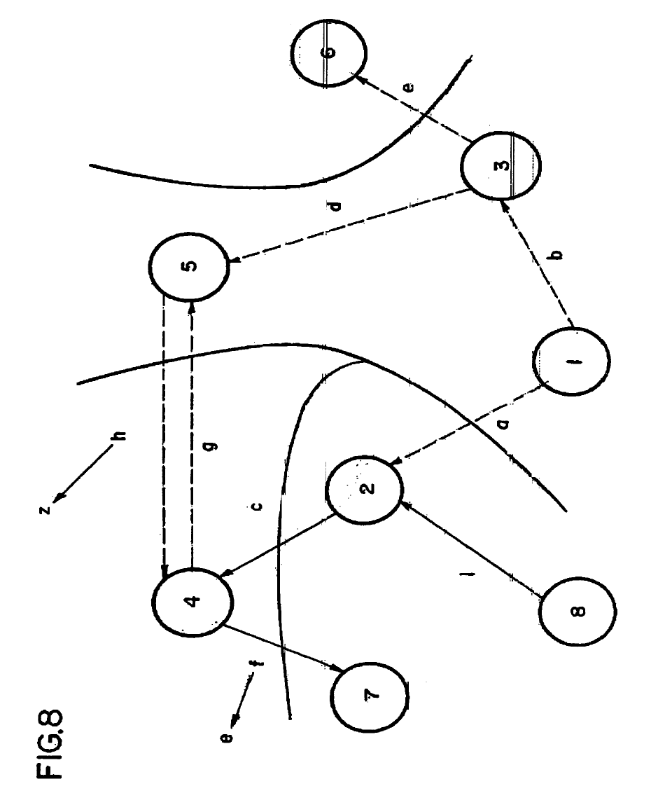

The transformation can be done in purely graph-theoretic terms. As shown in FIG. 6, let eᵢⱼ denote an edge from vertex vᵢ to vertex vⱼ. FIG. 7 depicts the transformation from the original graph to the converted graph. For example, αᵢ and αⱼ are the node costs and pᵢⱼ and sᵢⱼ are the primary and secondary costs. The following are the algorithmic steps for the transformation:
1. Define 2 new vertices s and t in the graph.
2. For each vertex v ∈ I, draw an edge from s to v with weight ∞.
3. For each edge eᵢⱼ ∈ E, create two new vertices xᵢⱼ and yᵢⱼ in the graph. Assign weights to the edges as depicted in FIG. 7.

Let G′ denote a conversion of original graph G. Given a containment in G, and corresponding cut C, note that there is exactly one possible corresponding cut C′ on G″ with a finite weight: referring to FIG. 7, if vᵢ is in C, xᵢⱼ must be in C′ because of the infinite weight on the edge between vᵢ and xᵢⱼ. Also, if vⱼ is in C, yᵢⱼ, must be in C′. Similarly, one can contend that given a finite weight cut of the converted graph, there is only one finite weight containment of the original graph.

Continuing to refer to FIG. 7, if C is a containment on G, corresponding cut C′ has the same cost on G′ as the containment C in G. And, if (G, D) is a target class graph with no dependencies and cut C′ is minimum on the converted graph G′, corresponding containment C is optimal on G.

There are a number of extensions of this case with no dependencies that can similarly be reduced to the problem of finding a minimum cut in a graph, the details of which are deferred to a full version.

Having considered the special cases of no secondary effects and no dependencies, the general case must be considered. In the most general setting, terminating service links has secondary effects and there are dependencies between the secondary effects of terminating links. There is no polynomial time algorithm to find the optimal containment and in fact, it is thought that this might be NP-complete. A simple heuristic is presented which produces a local optimum but is guaranteed to terminate in polynomial time.

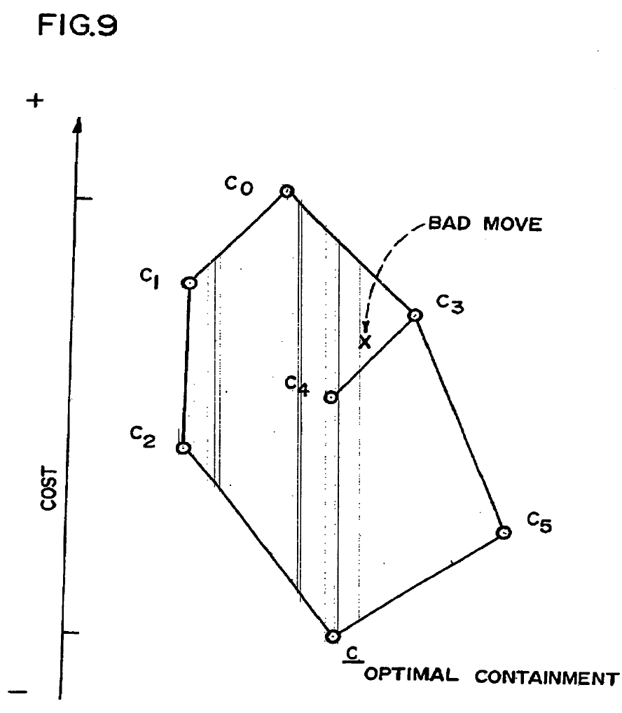

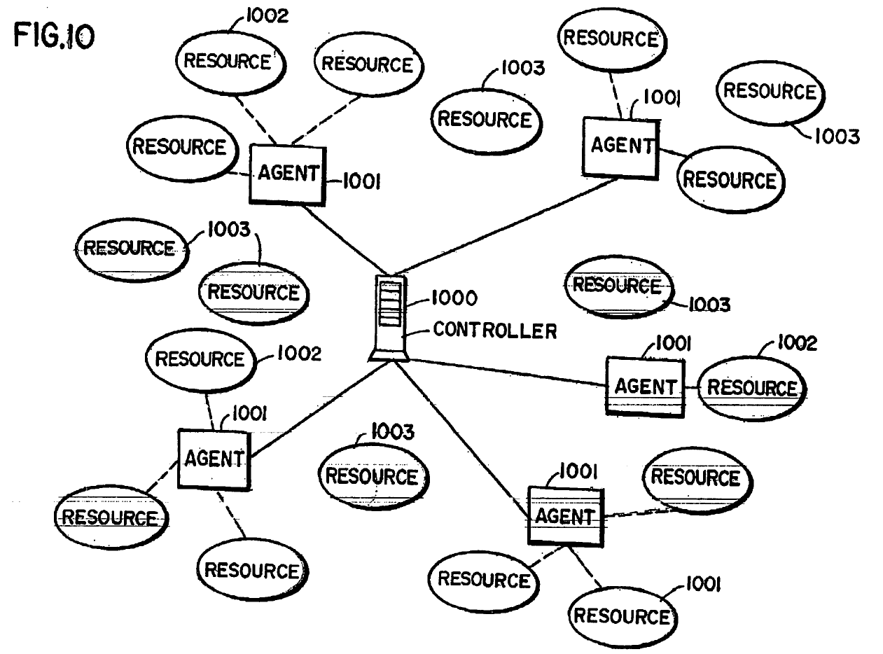

A “One-hop search,” as depicted in FIG. 8 is a simple heuristic which does not guarantee a global optima, but it does run in polynomial time. Starting with the smallest containment C₀ which is equal to the set I of nodes known to be affected, the containment is gradually extended in the direction of the edge with nonzero secondary cost. Extension is done by putting a node to which the current containment has an edge with a secondary cost. If an extended containment has a smaller cost, this extended containment is kept and used to search for a better containment. Therefore. containment extension continues until there is no secondary effect on outgoing edges. Let C₀→C₁→Cₓ denote this progression. Note that the Cₓ, is not necessarily the optimal containment since there are cases when the greedy heuristic can choose a bad-move while extending the current containment. This “bad move” is illustrated in FIG. 9.

Using the algorithms described above, it is possible to identify precisely which service links should be terminated to minimize the cost of containment. These can be automatically executed using the response platform described in the following portion of this disclosure.

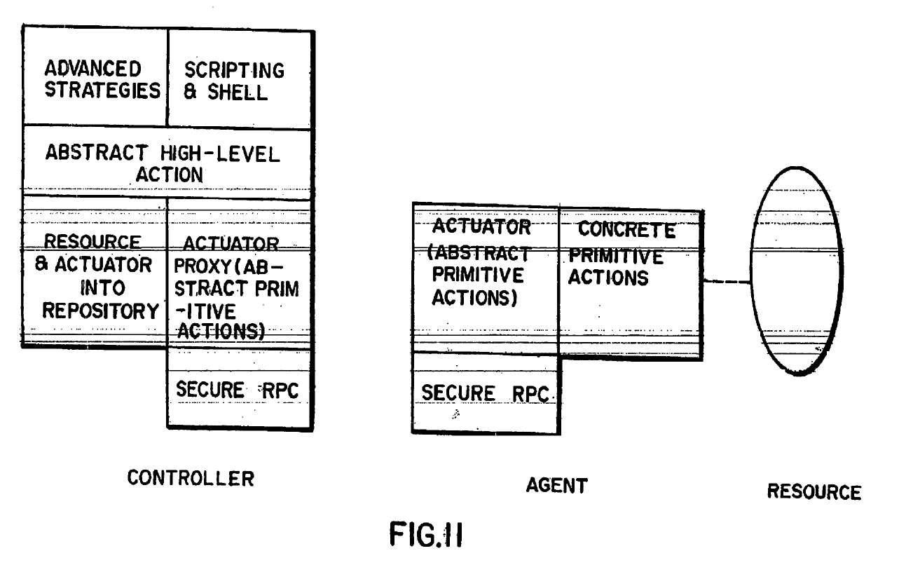

To use the platform for orchestrating a response reference is made to FIGS. 10, 11 and 12. FIGS. 10 through 12 disclose the architecture of the system comprising (a) an overview, (b) layering and (c) the relation among the important classes in a resource model.

As shown in FIG. 10, the system under consideration consists of a central controller 1000 and multiple distributed agents 1001. Agents 1001 provide the basic response action primitives whereas controller 1000 coordinates these agents 1001 to provide for global response. Each agent 1001 controls a set of resources 1002 providing control-points. It interacts with them in a resource-specific way, e.g., through an API or command-line tools if agent and resource co-reside or through resource specific protocols such as SNMP (See: Case, et al. Introduction and Applicability Statements for Internet Standard Management Framework. Internal request for comment RFC 3410, Internet Engineering Task Force, December, 2002, the contents of which are hereby incorporated by reference herein). Toward the controller, the agents provide a unified and abstracted actuator interface to the corresponding basic response actions based on a robust and secure RPC service. This is depicted as “Agent” elements in FIG. 11.

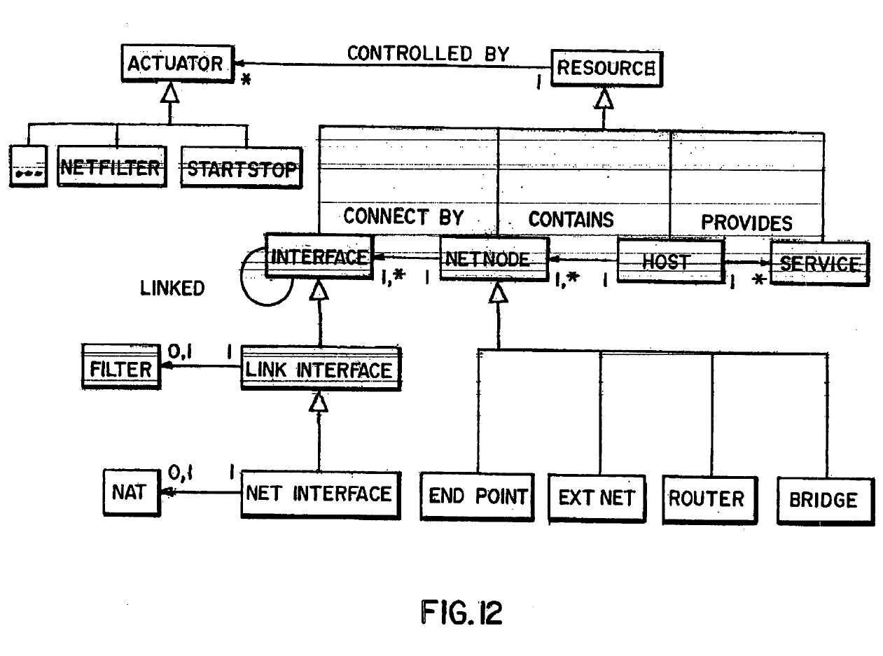

As previously noted, in many if not most situations it is unrealistic to assume that the administrator owns and directly controls all resources 1002, i.e., as shown in FIG. 10 a number of resources will have no associated agent 1003 which can control them or query them about their state. However, for effective response these resources and their state have to be considered as well. Therefore, the controller will try to discover the existence and state of all network resources and actuators, manually as well as with tools such as IDD (See: Gantenbein, et al., Categorizing Computing Assets According to Communication Patterns. In Gregori et al., editor, Advanced Lectures on Networking: NETWORKING 2002 Tutorials, volume 2497 of Lecture Notes in Computer Science, pages 83-100. Springer-Verlag, Berlin, Germany, May 2002, the contents of which are hereby incorporated by reference herein). The controller will then describe them in a simple abstract resource model as shown in FIG. 12 (for the model) and the controller will maintain a corresponding repository.

When remediation is necessary, this resource database can be used to identify affected resources, e.g., based on target class signatures. It also assists in figuring out whether (and how) these resources can be directly controlled through actuators or whether response has to be indirect, e.g., because there is no directly controlling actuator or the actuator cannot be trusted as it is co-located with an infected resource.

The resource model also defines in an actuator interface hierarchy the set of abstract basic actions previously mentioned. Examples of these abstract basic actions are the StartStop actuator which allows the controller to enable or disable a resource, such as a port on a switch or a program on a server, or the NetFilter actuator which allows the controller to filter network traffic. Furthermore, the controller provides means to combine these basic actions into sets of high-level actions. In particular, the knowledge base of the resource model is exploited to allow for intelligent aggregation of resources and the combined execution of a set of actions on them. The aggregation can be done based on the characteristics of their underlying software and hardware, i.e., target class signatures; based on their business functionality, e.g., dependencies among service links; or topological information, most notably the identification of the set of choke points which provide actuators to isolate a set of resources. An important factor in determining choke points is to assess the trustworthiness of the affected resources, e.g., for non-infected resources a collocated actuator is a desirable choice; whereas, for infected resources such an actuator is an inappropriate choice.

The goal of the infrastructure is twofold: It should enable the programming of (advanced yet involved) strategies such as the ones presented in the descriptions presented above and their integration into an overall autonomic defense system covering also intrusion sensors, vulnerability scanners and/or patch-management systems. However, it should also enable the system administrator to manually effect response actions in an ad-hoc, timely and fail-safe fashion. While implementing the previously described components in a high-level programming framework, Java™ in the instant case, provides an excellent basis to achieves the first goal, it does not yet handle the second goal. To address the second goal, the framework is extended with a simple scripting language and shell described below.

With respect to Scripting Language the major operation for the system administrator to manually effect response is to enter, in the interactive shell, actions of the form “α on γ” where γ is a group of hosts and α is the command to be executed on each of the hosts. The following discussion focuses on how, on the one hand, such host groupings can be defined, and, on the other hand, what kind of commands are allowed. The exact grammar of the scripting language is defined in EBNF [ISO96], the contents of which are hereby incorporated by reference herein.

With respect to the commands and the command grouping, commands can be either basic or compound. The basic actions are abstract basic actions as mentioned in the descriptions set forth above. More concretely, the current support in accordance with the present invention is for:
i.) filter parameters—This action is used to block network connections based on various criteria like initiator and responder of the connection, the network protocol and the initiator or responder ports.
ii.) stop parameters—This action halts the host or the program or service identified by the optional argument.
iii.) raise_alert_level—This action is used to increase the logging and alert level of the host.

Basic commands are allowed to be grouped by the operators and and or to form compound commands. The semantics are similar to the corresponding operators && and ∥ in the C programming language.

In considering host groupings, the main power of the language is the ability to perform response actions on a (large) group of nodes which are aggregated using various criteria, e.g., to quickly identify all vulnerable nodes. The language allows defining groups based on hostnarnes, IP addresses, subnetworks (e.g., 192.168.76.0/24 would identify all machines on the Class C network 192.168.76.0 and Extranet refers to machines external to the administrative domain) and also to invoke external programs such as network worm scanners to feed the controller with hosts. It also allows to the controller to compose groups based on the standard set operators on the group. The most powerful two operators to group resources, however, are the following: select from hosts where cond—This selects the set of hosts from hosts which match the target class signature cond. Condition can be general predicate logic terms with predicates based on the operating system, programs and services running on a host, their versions as well as actuator capabilities provided by that host.

Chokepoints of hosts. Applying the chokepoints of operator on a group hosts returns the closest group of actuators which allow to control traffic from and to the input group.

Execution and undo of actions are each essential. Given a command command, instantiating it on the group results in executing command on each of the nodes in the group. This action execution returns a handle that can be used to identify the action should it be required to be undone. This handle can be queried to check if the action was successfully executed. An action is successful if and only if the underlying command is successful on all its nodes. While it is not attempted to provide atomicity of the actions, it is essential to make sure to first determine that the command is possible on all nodes based on information in the resource repository and to do a best effort to make commands succeed. It is important to have an undo operation in responding to a worm attack. The response time available to an administrator is very short and he is probably under huge stress, should he make a mistake. Providing an efficient undo capability gives the administrator the freedom to err on the side of caution in case of an attack, like shutting down suspicious services, safe in the knowledge that undoing his actions is easy.

### EXAMPLE

In June 2002, CERT issued an advisory regarding a serious vulnerability in the popular web server Apache [Vula]. The vulnerability was in the handling of certain chunk-encoded HTTP 1.1 [FGM+99] requests that may allow remote attackers to execute arbitrary code. To illustrate how a system administrator responds to this incident with the instant tool, a sample script for this scenario is set forth below. The script identifies first vulnerable and infected nodes and then tries various containment steps with the least intrusive first until all options are exhausted.

| | |
|---|---|
| # CERT advisory CA-2002-17. | stop program = apache on StopSet ; |
| Vuln1 := select from intranet where | % update firewall rules on vulnerable nodes. |
| program = apache version=1.2.2; | % if possible |
| Vuln := select from intranet where | Remaining := Remaining diff StopSet; |
| program = apache 1.3 <= version <= | FilterSet := select from Remaining where |
| 1.3.24; | capability filter responderPort = 80 ; |
| Vuln := Vuln1 union Vuln2; | filter responderPort = 80 |
| Infected := ‘netvork_vorm_scanner’; | FilterSet as responder on FilterSet; |
| % Set of vulnerable and infected nodes resp. | |
| % Choke connections from infected nodes. | % Filter connections on filterpoints |
| filter Infected as initiator on | % for the remaining nodes |
| (chokepoints of Infected); | Remaining := Remaining diff FilterSet; |
| % Now, protect vulnerable nodes. | ChokeNodes := chokepoints of Remaining; |
| Remaining : Vuln; | filter port = 80 |
| | Vuln as responder on ChokeNodes; |
| % Stop apache servers where we can | % Raise alert level on vulnerable nodes. |
| StopSet := select from Remaining | raise_alert_level on Vuln; |
| where capability stop program = apache; | |

In this example, a prototype of the previously described architecture was built. The core of the controller is written in Java™. The scripting language is based on this Java core and the JavaCC compiler. The agents are all written in Perl and the secure RPC layer is currently simulated using ssh. As both tools are available on a wide variety of platforms, e.g., through cygwin on Windows, this does not limit the platform independence much and allows for faster prototyping than writing everything in Java. Security of such a platform is obviously paramount. With ssh confidentiality and integrity, Protection is obtained. As it is also crucial to timely deliver response actions even under attack, availability is also an important security requirement. To limit the power of corruption of agents, the agent runs as an a priori unprivileged user with separate ssh credentials and basic concrete actions are selectively enabled with appropriately restricted additional privileges using sudo. Corruption of the controller is somewhat mitigated by the fact that no commands can loosen the security policy in terms of confidentiality.

The simple and extensive language is intentional as the simplicity and the additional redundancy contribute greatly to its fail-safety. Given the potentially disastrous consequences of improper usage and the increased likelihood of mistakes given the pressure of dealing with security incidents, this is an essential design goal. The interactive shell is currently very limited. However, it is expected that its utility can be enhanced by adding features such as cmdline-editing, history and command-completion for keywords, program, services, and versions based on querying the underlying resource repository.

The automated intrusion response system of the present invention produces appropriate actions timely and correctly with a minimum impact on business. Target class signatures and service links to form a logical representation of the target network are used. The abstraction of the target network helps to search for the optimal containment efficiently by using graph theoretic algorithms.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A knowledge system for collecting and classifying asset and cost information about a network system comprising:
a. means for collecting information about all resources and all services in said network system;
b. means for collecting information about the dependencies between said resources and said services in said network system;
c. means for associating values with said resources, said services and said dependencies;
d. means for determining an expected repair cost of a vulnerability and/or intrusion and
e. means for classifying said collected information about said network system to form a target class signature by identifying resources and services which can be targeted by said vulnerability and/or intrusion.

2. A simulation system relating to cost-effective incident response security system comprising:
a. said knowledge system as defined in claim 1;
b. means to model vulnerabilities and/or intrusions;
c. means for simulating behavior of said network system for a given response strategy and a given vulnerability and/or intrusion model;
d. means for assessing an expected cost of said vulnerabilities and/or intrusions as determined by said vulnerability and/or intrusion model and response actions determined by said response strategy in terms of expected loss in said value of resources, services and dependencies and expected repair cost in said simulation.

3. A tool to generate, assess/evaluate and optimize configurations of said network system comprising.
a. means for generating different configurations of said network system;
b. the simulation system defined in claim 2;
c. means for evaluating the effectiveness of said configurations based upon said simulation system.

4. A tool to generate, assess/evaluate and optimize response strategies to vulnerabilities and/or intrusions in said network system comprising:
a. means for generating different response strategies of said network system;
b. the simulation system defined in claim 2;
c. means for evaluating the effectiveness of said strategies using said simulation system.

5. An incident response security system to manage vulnerabilities and/or intrusions in a network system comprising:
a. the knowledge system as defined in claim 1;
b. a set of actuators which in turn implements a set of basic commands;
c. a distributed runtime system which provides the capability of invoking a set of high level commands on an aggregated set of actuators in terms of said basic commands supported by said actuators;
d. a language and a related interactive shell that provides an interface to said distributed runtime system.

6. A cost-effective incident response security system which provides for the automatic or semi-automatic impact containment of vulnerabilities and/or intrusions comprising:
a. the incident response security system as defined in claim 5;
b. in response to detection of a vulnerability and/or intrusion in said network system, means to identify a target class signature for said vulnerability and/or intrusion of said network;
c. in response to identifying said target class signature, means for applying optimization algorithms to obtain an optimal set of response actions on said resources and on said services which will minimize an expected cost of said vulnerability and/or intrusion in terms of expected loss in said value of resources, services and dependencies and expected repair cost;
d. executing said optimal set of response actions.

7. A cost-effective incident response security system which provides for the impact containment of network intrusions comprising:
means for collecting information about all resources and all services in said network system;
means for collecting information about the dependencies between said resources and said services in said network system;
means for associating values with said resources, said services and said dependencies;
means for determining an expected repair cost of a vulnerability and/or intrusion and means for classifying said collected information about said network system to form a target class signature by identifying resources and services which can be targeted by said vulnerability and/or intrusion.
means for determining the business cost of a response to intrusions by a worm virus by quantifying the value of said resources of a target network, determining the cost of infection and following repair and projecting the values that services running on said resources provide to consumers of services;
means for collecting information to form a target class signature by identifying resources which are vulnerable to an intrusion by a worm virus, or which have been infected by a worm virus;
in response to detection of a vulnerability of a system or of an infection of the system, analyzing and evaluating alarms issued from sensor means to identify a target class of interest and defining the characteristics of said resources;
said analyzing and evaluation restricting the size of a domain of resource classes considered for optimization;
means for using said business costs, identifying costs of taking measures to protect said resources in said domain by terminating or reconfiguring said resources or controlling network traffic via network control elements;
in response to identification of said domain and determination of costs assigned to the various resources, applying optimization algorithms to obtain an optimal set of resources and actions which identify which services or resources in said system have to be terminated or reconfigured, depending upon the extent of the infection of said system, which will mitigate the cost of infection;
executing said optimal set of response actions.

8. A process for collecting and classifying asset and cost information about a network system to form a knowledge system comprising:
a. collecting information about all resources and all services in said network system;
b. collecting information about the dependencies between said resources and said services in said network system;
c. associating values with said resources, said services and said dependencies;
d. determining an expected repair cost of a vulnerability and/or intrusion and
e. classifying said collected information about said network system to form a target class signature by identifying resources and services which can be targeted by said vulnerability and/or intrusion.

9. A process for making a simulation system relating to cost-effective incident response security system comprising:
a. forming a knowledge system as defined in claim 8;
b. modeling vulnerabilities and/or intrusions;
c. simulating behavior of said network system for a given response strategy and a given vulnerability and/or intrusion model;
d. assessing an expected cost of said vulnerabilities and/or intrusions as determined by said vulnerability and/or intrusion model and response actions determined by said response strategy in terms of expected loss in said value of resources, services and dependencies and expected repair cost in said simulation.

10. A process for generating, assessing/evaluating and optimizing configurations of a network system comprising:
a. generating different configurations of said network system;
b. utilizing said simulation system as defined in claim 9;
c. evaluating the effectiveness of said configurations based upon said simulation system.

11. A process for generating, assessing/evaluating and optimizing response strategies to vulnerabilities and/or intrusions in said network system comprising:
a. generating different response strategies in said network system;
d. utilizing said simulation system as defined in claim 9;
e. means for evaluating the effectiveness of said strategies based upon said simulation system.

12. A process for managing vulnerabilities and/or intrusions in a network system to form an incident security system comprising:
a. forming a knowledge system as defined in claim 8;
b. applying a set of actuators to said system which in turn implements a set of basic commands;
c. utilizing a distributed runtime system to provide the capability of invoking a set of high level commands on an aggregated set of actuators in terms of said basic commands supported by said actuators;
d. utilizing a language and a related interactive shell with said system that provides an interface to said distributed runtime system.

13. A process for providing for the automatic or semi-automatic impact containment of vulnerabilities and/or intrusions to form a cost-effective incident response security system comprising:
a. forming the incident response security system as defined in claim 12;
b. in response to detection of a vulnerability and/or intrusion in said network system, identifying a target class signature for said vulnerability and/or intrusion of said network;
c. in response to identifying said target class signature, applying optimization algorithms to obtain an optimal set of response actions on said resources and on said services in said network system which will minimize an expected cost of said vulnerability and/or intrusion in terms of expected loss in said value of resources, services and dependencies and expected repair cost;
d. executing said optimal set of response actions.

14. A computer program product comprising a computer useable medium including a computer readable program, wherein said computer readable program when executed on a computer causes said computer to collect and classify asset and cost information about a network system to form a knowledge system comprising:
a. collecting information about all resources and all services in said network system;
b. collecting information about the dependencies between said resources and said services in said network system;
c. associating values with said resources, said services and said dependencies;
d. determining an expected repair cost of a vulnerability and/or intrusion and
e. classifying said collected information about said network system to form a target class signature by identifying resources and services which can be targeted by said vulnerability and/or intrusion.

15. A computer program product comprising a computer useable medium including a computer readable program, wherein said computer readable program when executed on a computer causes said computer to make a simulation system relating to cost-effective incident response security system comprising:
a. forming a knowledge system as defined in claim 14;
b. modeling vulnerabilities and/or intrusions;
c. simulating behavior of said network system for a given response strategy and a given vulnerability and/or intrusion model;
d. assessing an expected cost of said vulnerabilities and/or intrusions as determined by said vulnerability and/or intrusion model and response actions determined by said response strategy in terms of expected loss in said value of resources, services and dependencies and expected repair cost in said simulation.

16. A computer program product comprising a computer useable medium including a computer readable program, wherein said computer readable program when executed on a computer causes said computer to generate, assess/evaluate and optimize configurations of a network system comprising:
a. generating different configurations of said network system;
b. utilizing said simulation system as defined in claim 15;
c. evaluating the effectiveness of said configurations based upon said simulation system.

17. A computer program product comprising a computer useable medium including a computer readable program, wherein said computer readable program when executed on a computer causes said computer to generate, assess/evaluate and optimize response strategies to vulnerabilities and/or intrusions in said network system comprising:
a. generating different response strategies in said network system;
b. utilizing said simulation system as defined in claim 15;
c. means for evaluating the effectiveness of said strategies based upon said simulation system.

18. A computer program product comprising a computer useable medium including a computer readable program, wherein said computer readable program when executed on a computer causes said computer to manage vulnerabilities and/or intrusions in a network system to form an incident security system comprising:
a. forming a knowledge system as defined in claim 14;
b. applying a set of actuators to said system which in turn implements a set of basic commands;
c. utilizing a distributed runtime system to provide the capability of invoking a set of high level commands on an aggregated set of actuators in terms of said basic commands supported by said actuators;
d. utilizing a language and a related interactive shell with said system that provides an interface to said distributed runtime system.

19. A computer program product comprising a computer useable medium including a computer readable program, wherein said computer readable program when executed on a computer causes said computer to provide for the automatic or semi-automatic impact containment of vulnerabilities and/or intrusions to form a cost-effective incident response security system comprising:
a. forming the incident response security system as defined in claim 18;
b. in response to detection of a vulnerability and/or intrusion in said network system, identifying a target class signature for said vulnerability and/or intrusion of said network;
c. in response to identifying said target class signature, applying optimization algorithms to obtain an optimal set of response actions on said resources and on said services which will minimize an expected cost of said vulnerability and/or intrusion in terms of expected loss in said value of resources, services and dependencies and expected repair cost;
d. executing said optimal set of response actions.
